(19) United States
(12) Patent Application Publication
(10) Pub. No.: US 2025/0173171 A1
(43) Pub. Date: May 29, 2025

(54) Method for generating user specific interfaces using Generative UI

(71) Applicant: Verses AI, Inc., Los Angeles, CA (US)

(72) Inventors: Alexander D.D. Tschantz, Brighton (GB); Tim Verbelen, Dendermonde (BE); Mahault Albarracin, Montreal (CA); Gabriel Joseph Bradley Rene, Los Angeles, CA (US); Arisa Scott, Renton, WA (US); Jason G. Fox, Dallas, TX (US); Alessandro Muzzi, Montecchio Emilia (IT); Darin Bunker, Saratoga Springs, UT (US); Ran Wei, Austin, TX (US); Troy Edwards, Winchester, VA (US); Ryan Andrew Tarek Zaki, Virginia Beach, VA (US)

(21) Appl. No.: 18/963,247

(22) Filed: Nov. 27, 2024

Related U.S. Application Data
(60) Provisional application No. 63/604,123, filed on Nov. 29, 2023.

(51) Int. Cl. G06F 9/451

(52) U.S. Cl. CPC G06F 9/451

(57) ABSTRACT

In a method of generating a user interface, a user query is submitted to an encoder LLM which provides variable elements used to infer novel variable elements using a factor graph document database, which are in turn passed to a decoder LLM to generate user interface elements.

### FIELD OF INVENTION

User interfaces and artificial intelligence agents.

### BACKGROUND

User Interfaces, also known as “UIs” function as the point of contact between a human user and the software that operates the functionalities required to fulfill the goals of the human user. UI elements include the screens, the sounds, the search bar, the style of the interface, the format under which the data is presented, etc. UIs are designed by UI designers to optimize the user experience when interacting with content. The optimization process takes into account the nature of the data, and the user type. For instance, a navigation application will consider geospatial data and provide an interface such as a route, under the assumption that the user will want to navigate to different locations. This assumption, however, is fixed for each UI. This is so because UIs are designed beforehand, to serve predefined functionalities. For instance, a UI for navigation could not at the same time display a map and a trend line if a user were to enter a query such as “where is the pasta restaurant with the best trend in stock price”. UIs are thus static and preprogrammed, which makes it difficult and costly to develop interfaces able to serve diverse user needs while providing a user experience that aligns the data, or information type and the functionalities offered by the interface.

Previous attempts at solutions for dynamic UIs have used rule-based systems based on large sets of predefined responses that could match a wider diversity of queries, as well as learning models (e.g., machine learning) to learn the most probable responses based on training data. However, these solutions either lack the ability to fit finer-grained user demands or require prohibitively large amounts of data to learn how to properly fit them. Rule-based systems are limited by their predefined rules and struggle with queries that fall outside these rules, and machine learning models, while capable of handling a wider range of queries, often require large amounts of training data. Furthermore, existing solutions often do not consider the UI/UX component of the interaction. The format in which a response is presented can significantly impact the user's experience and understanding of the information.

### SUMMARY

The claimed method for generating dynamic user interfaces, also referred to herein as a Generative UI (GENUI) allows the user to access personalized and context-aware information when interacting with the GENUI. The present invention goes beyond the limitations in prior art solutions by providing a method that allows for inferring user-relevant models directly out of the user query, instead of learning user relevant models out of rules or out of a large dataset. The claimed method creates a dynamic GENUI by mapping the user queries to relevant variables that are extracted from the user query using a large language model (LLM) as discussed further below with respect to the definition section, and comprising theg decomposition of the user query into observed query variables that are used to infer hidden response variables and which are used to construct the code for a user's query-specific UI.

### BRIEF DESCRIPTION OF THE DRAWINGS

FIG. 1 shows one embodiment of the structure of a simple graph database with two nodes;

FIG. 2 shows one embodiment of the structure of a computation graph database;

FIG. 3 shows one embodiment of a factor graph database treated as a computation graph database;

FIG. 4 is a flowchart of the steps involved in one embodiment of a method for generating dynamic user interfaces using factor graph document databases;

FIG. 5 is a flowchart of the steps involved in one embodiment of an encoder method, and

FIG. 6 shows the structure of one embodiment of a factor graph document database including the observed query variables.

### DETAILED DESCRIPTION

### Definitions

### Large Language Model

A Large Language Model (LLM) is a model of the class of computational models known as foundation models. Foundation models are computational models that are pre-trained on a large amount of data. LLMs are foundation models that have been trained on text data, specifically (e.g., text files found online). By analogy, an LLM is like a person who would have read and encoded the information coming from a vast amount of texts (e.g., has read many books, websites, etc.) and that can combine the knowledge that she has acquired to respond to various queries (e.g., “what is the color of the sky?”). An LLM is built out of the combination of three elements: (i) text data, (ii) a computational architecture, and (iii) a training process. Depending on the LLM, the computational architecture will differ. For instance, for well-known LLMs such as GPT-3, the computational architecture used is a neural network that has a transformer architecture. Transformer architectures perform 1-to-many string comparisons (e.g., comparing a sentence to all similar sentences, or more precisely “tokens”) to then generate new sentences that are informed by the syntax of the already known sentences. The process starts with an encoding step that involves: (i) transforming the natural language into token embeddings, which are numerical representations of the words (i.e., strings of numbers), (ii) estimating the normal position of the words and sentences, with respect to one another, which is made possible by the conversion of the words into their numerical equivalent (e.g., “The” comes before “sky”), (iii) tracking the normal relationship between the words turned into numerical representations using a process called self-attention (e.g., words like “blue” relate to nouns like “sky”, and not articles like “the” when they are positioned after names like “sky”). The encoded sentences can then be used to perform various mathematical operations to further compare the sentences, find similar sentences, predict what words could be used to complete the sentences, find sentences that respond to other sentences, etc. With respect to how LLMs are used in general, and in this invention, text inputs known as “prompts” are used as inputs to the LLM to generate text output that functions as responses to the prompt. Prompts can be questions (e.g., what is the color of the sky?) or imperative statements (e.g., write a computer code that can be implemented to generate sky in a game engine). Prompts are structured in a way that can elicit the desired response—similar to how one would structure a question posed to humans so as to elicit a certain response. The activity of engineering a prompt to elicit the desired response is called “prompt engineering”. In summary, LLMs are used as tools for responding to natural language queries, just like calculators may be used for responding to a query in mathematical language (e.g., “what is 2+2?”). Prompt engineering is the activity of asking the right question to an LLM (e.g., asking “what is 2+2” when looking for an addition instead of asking “what is 2×2”). An LLM is a foundation model trained on text data that takes as input an engineered text “prompt”, and processes that prompt to generate an output, which is the response that corresponds to the prompt.

The present invention is not limited to the use of LLMs based on transformer neural networks, but includes LLMs in general. The claimed method covers any computer system able to receive a prompt-like input and generate the appropriate response to the prompt.

### HSML Factor Graph Document Database

Databases are queryable data stores. The three common classes of databases are relational databases, graph databases, and vector databases. Compared to relational and vector databases, graph databases store data in a way that allows for querying by looking at parent-child relationships between the stored entities (e.g., “give me the child entities to the Steve entity”). Graph databases can represent entities in the world and the relationships between them. Entities are any physical or conceptual “thing” that has meaning in the real world (e.g., a robot, a sofa, a waypoint in space that refers to a location where one can go, a specification of an activity, etc.). Relationships between entities are expressed as edges that connect source nodes (e.g., the parent or cause nodes) and the destination nodes (e.g., the children or the consequence node), and that can give cause-consequence, or parent-child information.

A vector graph document database is a queryable data store. Vector graph document databases are databases whose structure allows for mix queries combining relational, graph, and vector databases type queries (e.g., “give me the products whose prices are greater than 5 dollars and that are sold by the company X, and whose description best matches that of sunglasses”).

A computation graph database is a graph database for a computation graph. The computation graph is a directed graph, which includes source and destination nodes that represent variables, and further includes edges representing transformations in the value of a destination node that can occur when an update happens to a connected source node. The terms “entity”, “node” and “variable” are used interchangeably. A computation graph database is thus a graph database that can be used to perform mathematical operations over the stored entities.

A factor graph is a type of probabilistic graphical model that can be used to perform inferences over the entities represented by the nodes in the graph. A factor graph consists of two types of nodes: (i) factor nodes, which represent factors or functions that relate multiple variables together (e.g., the function that multiplies the elements x1,x2,x3 . . . of a variable X with the elements y1,y2,y3 . . . of a variable Y), (ii) and variable nodes, which represent the variables in the model. For the factor graphs used in this invention, we use a bipartite graph representation and partition the graph into factor nodes and variable nodes. The factor nodes are connected to the variable nodes that they depend on, and the graph structure reflects the conditional dependencies between the variables. Variable nodes are denoted by circles and correspond to variables over which the inference algorithm applies. Variable nodes can also define entities of an HSML vector graph document database (see definition below of HSML). Factor nodes are denoted by squares and denote the relation between variables, or entities. In the context of this invention, they encode the data that represents the probabilistic relation between entities, and that can be used by an inference program to perform probabilistic querying.

A factor graph document database is a type of computation graph database that uses a factor graph to implement a vector graph document database over which factor graph operations such as message passing can be performed. Factor graph operations allow the inference of values of any desired nodes in the vector graph document database. Thus, factor graph document databases are computation graph databases structured as factor graphs, and that are able to perform factor graph operations such as message passing.

Hyperspace Modeling Language (HSML) is a structured modeling language used to link entities in a knowledge graph. The syntax of HSML includes 1 main entity type and 4 entity subtypes. All entities are documents written in JSON format. The main entity document (e.g., for an object such as “Ray-Ban sunglasses in a warehouse”) includes a Unique IDentifier (UID) tag field called Spatial Web Unique IDentifier (SWID), a name field (optional), a description field (optional), and a schema, or array of schema field.

The schema is the first document subtype. It contains a vectorization field which indicates how to convert the entity, to which the schema belongs, into a vector representation of that entity (i.e., vectorization strategy). The vectorization field is (1) an array of objects that contains information about the entity's properties, (2) a vectorization program (i.e., algorithmic operations) to vectorize the entity, and (3) a vector space.

The vector space is the second subtype, and describes the structure that contains the vectors of the vectorized entity. Vector spaces have two fields, which are the distance metric field (e.g., cosine distance between vectors) and the length field (i.e., vector dimensionality).

The third subtype is the link. A link is a relation between two entities (e.g., “Ray-Ban sunglasses” are sold by “the company X”) and contains a source-entity UID field and a destination-entity UID field. HSML allows for two types of links: normal links and data links. Normal links provide parent-child relationship information between entities. Data links are links that allow for performing operations on entities and contain a transform field, which links to a program that can perform an operation between entities (e.g., decrement the amount of sunglasses by 1 when selling a pair).

Data link programs are the fourth and final subtype, and include two fields, which are the program field-indicating the program to be executed-and the data field-indicating the type of data over which the program should execute.

Importantly, the present invention is not limited to the use of HSML but could be implemented using other modeling languages.

The HSML factor graph document database is a queryable database using the syntax of HSML. The HSML factor graph document database can be treated as a factor graph thereby allowing for performing inferences about the relation between the entities contained in the database.

### Observed and Hidden Variables

The factor graph document database variables for the inference model include hidden, unknown variables, and known, or observed variables. The hidden variables are inferred based on the observed variables. The observed variables are derived from the user query. For that reason, observed variables are called query variables. The hidden variables allow generating the response to the user. For that reason, the hidden variables are called response variables. The inference of the response, or hidden variables is done based on the observed, query variables, and allows the GENUI to generate the content and format of the response to be communicated. The response and query variables are the following:

### Query Variables (i.e., Observed Variables)

Query domain The query domain variable refers to the class to which the entities in the query belong (e.g., for a “buying apples” query, the domain would be “fruits”).

Query domain values These are the values that the domain elements can take (e.g., orange, apple, banana, etc. as elements of “fruits”)

### Response Variables (i.e., Hidden Variables)

Response format elements The response format refers to the type of response that would be appropriate to communicate the information queried by the user (e.g., for a “buying apples” query, the response format would be a map with comparative prices at different locations). Each response format element is predefined, and is encoded in JSON format.

Response query variables The response query variables are inferred from the query variables (e.g., apples can be found at “the grocery store”). The response format elements match the response query variable (e.g., if the response query variable is a “store”, then the response format element for the UI interface will be a map).

It will be appreciated that the above examples are not in any way intended to limit the invention, which is not limited to the listed query and response variables, but covers any variable aimed at decomposing a user query.

In one embodiment of this invention, the code for creating the GENUI is implemented as a class in the Python programming language and is composed of:
an encoder method that uses an LLM to decompose a user query into query variables,
an inference method that uses an HSML factor graph document database to infer hidden response variables based on observed query variables,
a decoder method that uses an LLM and the inferred response variables to generate a query-specific user interface (UI).

While the inference method is described here with respect to HSML, the claimed method is not limited to the use of an HSML factor graph document database for the inference of hidden response variables. The claimed invention applies to any method that can be used to infer hidden variables from observed variables, such as neural networks or rule-based systems.

As an illustration of the way GENUI produces tailored user interfaces to respond to a user query, we present a scenario in which a user makes a query for “where can I go buy apples?”. We show how the encoder, inference, and decoder methods are implemented to generate a user interface that displays user specific information. In the current scenario, the personalized information amounts to information that takes into account implicit user relevant facts such as apple stocks across different stores as well as transportation options in providing the requested information. GENUI will generate a location and map UI that gives the store location that will be most easily accessible transport wise (e.g., using the car vs. using public transportation when considering parking availability) and that will most likely have apples in store.

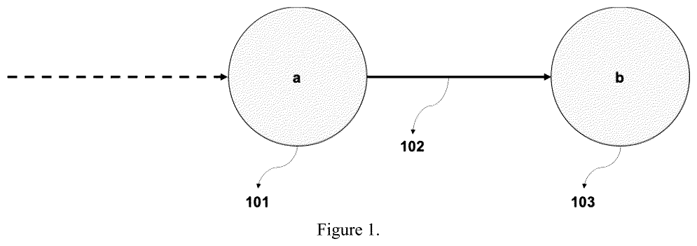

FIG. 1 illustrates the structure of a simple graph database with two nodes: source node 101, and destination node 103, related to each other by an edge 102. A graph database gives parent-child information about the entities (which are defined by the nodes) contained in the database. The graph database represents parent-child information by using edge 102 relating the source entity 101 and the destination entity 103.

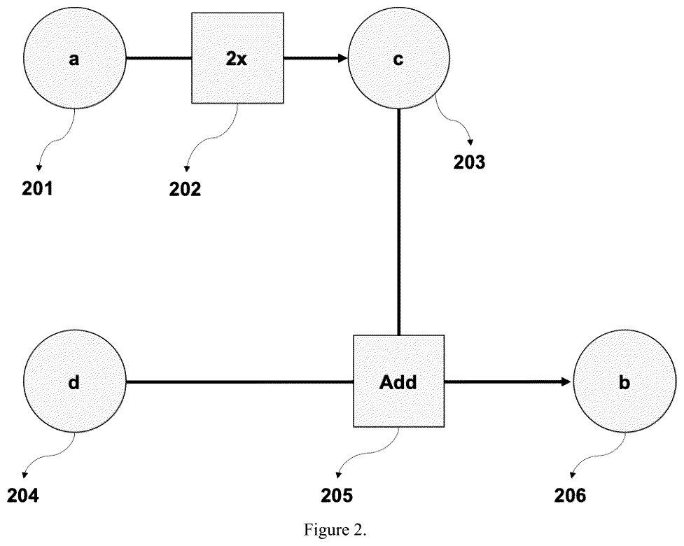

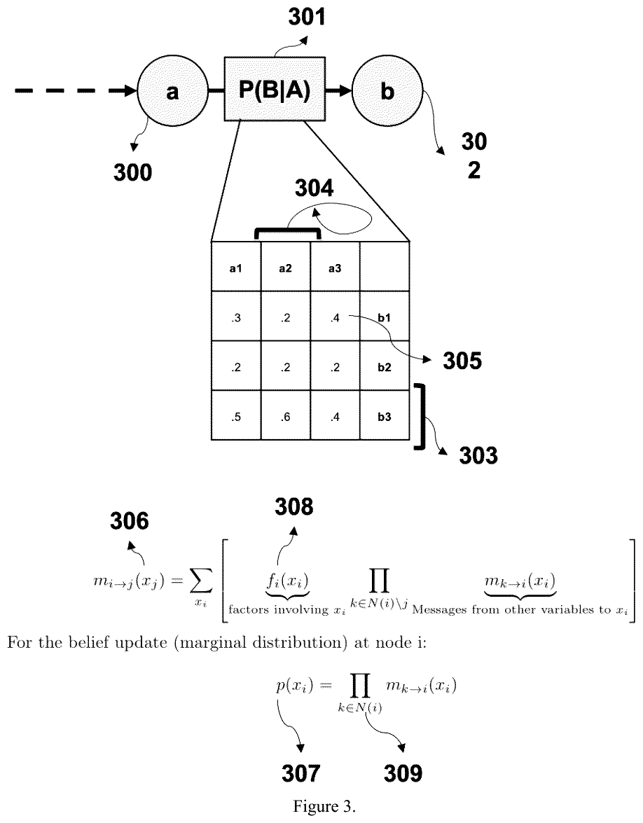

FIG. 2 illustrates the structure of a computation graph database performing a mathematical operation “b=2a+d” over the source node “a” and a destination node “b”. The update rule is represented as a mathematical operation whose description is encoded in the graph database (e.g., operations represented as squares in FIGS. 2 and 3 operating on factor nodes and intermediary nodes) and operated through a call to a programming language. In FIG. 2, this is defined by source node a (201) being subjected to a multiplication operation 202 to define interim node 203. Node d (204) is added by “Add” operation 205 to the value of interim node 203 to define destination node b (206). The function of a computation graph database is to update a destination node (e.g., b) when a change in a source node (e.g., a) happens. When a change in entity a (201) is observed, the value of the entity b (206) is updated. The update rule is operated through two transforms, which are transform 202, which calculates two times the value of a (2a) to define variable c 203, and transform 205, which adds variable c to variable d 204 to update variable b 206. This operation thus requires an intermediary entity c 203 that is constructed for the purposes of evaluating the expression operated by the transform in 205.

FIG. 3 shows the structure of a factor graph database treated as a computation graph database. As a type of computation graph database, a factor graph database can perform operations such as message passing to update the variables stored in the database. The factor graph relates a source node a (300) and a destination node b (302), and their relating factor encoding information 301 about the conditional probability of elements of the variable b relating to elements of the variable a. The probabilities are presented as mappings in matrices (or in tensors). Reference numeral 304 indicates that the column of the matrix corresponds to a probability distribution (i.e., must sum to 1, e.g., 0.2+0.2+0.6). Each cell encodes a probabilistic mapping between the variable represented by the column (e.g., elements of a such as a1, a2, a3) and the variable represented by the rows (e.g., elements of the variable b such as b1, b2, b3). Reference numeral 303 indicates the rows that represent the observed variable, or the children of an entity. Reference numeral 305 indicates that the probability of b1 being related to a3 is 40% (0.4). The mathematical operation performed by the factor graph database is an inference algorithm represented in the equation (306-309). The algorithm operation is a message-passing algorithm that computes the message from node i (e.g., a) to node j (e.g., b) defined as the summation over all possible values of the entity i such as encoded by the data field of the data link 306. 307 is the marginal probability of node i, 308 is the factor associated with node i, and 309 is the set of neighbors of node i. The inference method of the present invention uses a factor graph document database implementing the HSML modeling language to perform inference over hidden response variables upon receipt of observed query variables.

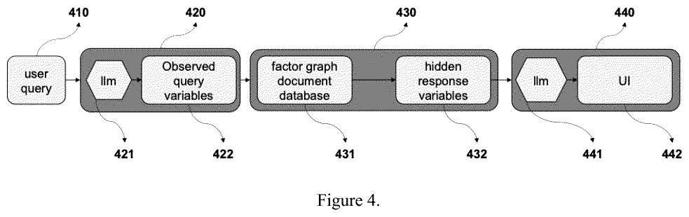

FIG. 4 is a flowchart of the steps involved in the method of one implementation for generating dynamic user interfaces using factor graph document databases. A user (410) query is acted upon by the encoder method (420) that uses an LLM (421) to convert natural language query into query variables (422). The query variables are used as input to the inference method (430), which in this embodiment, uses an HSML factor graph document database (431), but can use any inference method to infer hidden response variables (432). The decoder method (440) receives the hidden response variables, which are passed to an LLM (441) to build the elements for the user tailored UI (442).

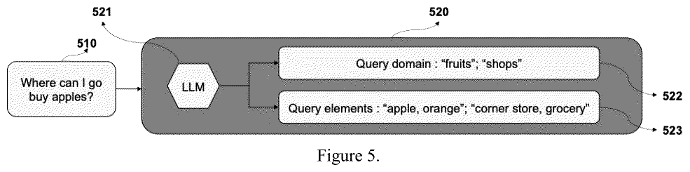

FIG. 5 is a flowchart of the steps involved in the encoder method (520). The encoder method defines the observed query variables used in the inference of hidden response variables. The query (510) is passed to a LLM (521) along with an engineered prompt. This is made possible by the encoder method part of the program of the invention, which in one embodiment is a class in Python programming language. The encoder method sends the query and the engineered prompts to the LLM through a call to a LLM Application Programming Interface (API) programmed in the encoder method. A LLM API is typically designed to receive prompt and return the response. The query is passed to the LLM using the following prompts:
Prompt 1
   “Identify the query domain of the following query: where can I go buy apples?”
Prompt 2
   “Identify and provide examples of objects in the query domain of the following query: where can I go buy apples?”

### Prompt 3

“Identify the purpose of the following query: where can I go buy apples?”

### Prompt 4

“Identify what is to be achieved with the following query: where can I go buy apples?”

In the above example, the highlighted portions determine the content of relevance in the user query. The encoder method identifies the query domain (522) and the query elements (523). The claimed invention applies to any engineered prompt that when passed to a computer system along with a query would return the query domain, and the query elements.

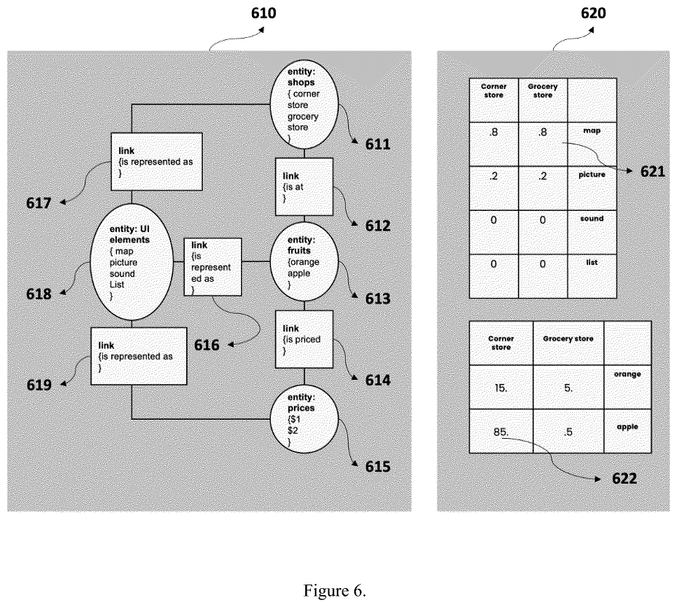

FIG. 6 illustrates the structure of the factor graph document database in this example, including the observed query variables. The inference method that applies to the factor graph document database (610) is used to perform the inference according to the algorithm presented in FIG. 3. Based on the observed query variables that have been extracted by the LLM from the query “where can I go buy apples” a factor graph can be constructed with a “shop” entity (611) with elements “grocery store” and “corner store”.

This invention is not limited to the construction of new factor graphs, but also applies to already existing factor graphs. In the case of an existing factor graph, the query variables are simply used to index the probabilities in the existing factor graph that correspond to the query variable. The entity in reference numeral 611 would be linked with a link entity (612) indicating “is at” to a fruit entity (613) with variables “orange” and “apples”. The Fruit entity may be connected through another link (614) to a “price” entity with elements “$1” and elements “$2”. Finally, each of the entities may be linked (616-617-619) to a “UI element” (618) entity with elements “map”, “picture”, “sound” and “list”. The factors (620) of the factor graph document database may encode the conditional probabilities between all the possible linked entities. For instance, the link between the entity “fruit” and the entity “shops” might include probabilistic information encoded in a factor indicating that there is 85% chance that apples will be found at the corner store (622). Similarly, a factor implemented by reference numeral 617 includes probabilistic information about the kind of UI elements appropriate for displaying information about the grocery store or the corner store (e.g., 80% of the time the information should be displayed as a map (621). The inference method is used to infer the most probable UI element, along with the most probable “shop” where the apple will be found, along with additional information that may be contained in the factor graph document database such as “prices” and their most appropriate UI format. The decoder method is then applied to transform into query specific UI the inferred response variables, here, the response format variable, along with the inferred information about where and at what price apples will most probably be found (e.g., displaying a map for the store, a picture for the fruit, and a list for the price). To obtain the code, which is rendered in JSON format, for the UI, the decoder method passes a series of engineered prompts to a LLM. This is made possible by the decoder method part of the program of the invention, which in one embodiment is a class in Python programming language. The decoder method sends the query and the engineered prompts to the LLM through a call to a LLM Application Programming Interface (API) programmed. A LLM API is typically designed to receive prompt and return the response. The response variables are passed to the LLM via the LLM API using the following response variables:
Prompt 1
   “Build a UI out of the appropriate UI elements out of the following list of UI elements: [list of UI elements response variable]”
Prompt 2
   “Incorporate to the UI information the following variables: [list of response query variables]”

The claimed invention is not limited to the use of JSON format. The claimed invention applies to any engineered prompt that when passed to a computer system along with response variables and inferred query variables would return the code for a UI.

1. A method of generating a user interface in response to a user query, comprising,
creating or accessing a predefined list of generic user interface elements in Java Script Object Notation (JSON) format,
creating or accessing a predefined list of one or more encoder prompts that can be passed to a computer system capable of comparing data strings representing natural language, wherein the language of the encoder prompts determines the content of relevance in a user query,
receiving a user query,
decomposing the user query into component variables,
generating source nodes and destination nodes for a factor graph document database out of the component variables, or indexing source nodes or destination nodes matching the component variables if the factor graph document database already contains source nodes and destination nodes that match the component variables,
using the factor graph document database to infer new query component variables that relate to the user query variables according to rules of probability,
creating or accessing a predefined list of one or more decoder prompts,
composing a user interface by combining the decoder prompts, the generic list of user interface elements, the user query variables, and the inferred query component variables.

2. A method of claim 1, wherein the user query is a natural language query presented to a Large Language Model (LLM), which decomposes the user query into component variables in natural language.

3. The method of claim 1, wherein the factor graph document database is structured using a modelling language that enables computation over the stored entities.

4. The method of claim 3, wherein the modeling language defines a Unique IDentifier (UID) tag field for each entity.

5. The method of claim 4, wherein the entities include source entities and destination entities stored as source nodes and destination nodes in the factor graph document database, a schema, normal links that relate at least some of the source entities with at least some of the destination entities according to their causal or parent-children relationships, and data links capable of computation over source and destination entities.

6. The method of claim 4, wherein the data links relate at least some source entities with at least some destination entities according to their causal or parent-children relationships and perform computations over the related entities.

7. The method of claim 1, wherein the predefined list of decoder prompts is passed to a large language model (LLM).

8. The method of claim 7, wherein the language of the decoder prompt asks the computer system to compose a user interface out of the generic list of user interface elements.
